(19) United States
(12) Patent Application Publication
(10) Pub. No.: US 2023/0311336 A1
(43) Pub. Date: Oct. 5, 2023

(54) OFFLINE-TO-ONLINE PROGRAMMING TEACHING SYSTEM FOR ROBOT ARM TRAJECTORY AND METHOD THEREOF

(71) Applicant: NATIONAL TAIPEI UNIVERSITY OF TECHNOLOGY, Taipei (TW)

(72) Inventors: Hsien-I LIN, Taipei (TW); YUDA RISMA WAHYUDI, Taipei (TW)

(21) Appl. No.: 17/705,282

(22) Filed: Mar. 26, 2022

(51) Int. Cl. B25J 11/00; B25J 13/08; B25J 13/02; B25J 9/00; B25J 9/16

(52) U.S. Cl. CPC B25J 13/025; B25J 9/0081; B25J 9/1633; B25J 9/1671; B25J 11/0065; B25J 13/085

(57) ABSTRACT

An offline-to-online programming teaching system for robot arm trajectory and a method thereof are disclosed. In the system, a trajectory conversion and control device establishes an offline polishing reference trajectory and performs a polishing operation simulation using the offline polishing reference trajectory. The trajectory conversion and control device converts data flow of the simulation into a polishing reference trajectory. The trajectory conversion and control device calculates a deviation between an end position of the series robot arm and the polishing reference trajectory to generate a guidance force information. A haptic device adjusts the position command based on the guidance force information to achieve the technical effect of integrating offline-to-online programming to provide robot arm trajectory teaching.

### BACKGROUND

### 1. Technical Field

The present invention is related to a robot arm trajectory teaching system and a method thereof, and more particularly to a system of integrating offline-to-online programming to provide robot arm trajectory teaching, and a method thereof.

### 2. Related Art

In recent years, robot arms are popular tools for manufacturing in the industrial production environment. Generally, robot arms are operated along pre-programmed trajectories to perform production, and complicated postures and operations take a lot of time and have a certain degree of difficulty in programming the trajectories of the robot arms.

Particularly, in the process of using robot to perform a polishing operation for the production of wooden furniture, wooden furniture usually has a more complex surface and a variety of assemblies, so multiple operation positions must be set in the robot arm, and it causes the complexity of the trajectory programming of the robot arm and reduces the utility of the trajectory programming.

In the actual industrial production environment, manners of programming the robot arm are mainly classified into offline programming and online programming. Particularly, the online programming is that the user operates a teaching device to remotely control the robot arm to program the trajectory of the robot arm. Because of having convenience, the online programming is used to program the trajectories of the robot arms in most industrial production fields.

The offline programming is mostly to select 3D CAD model first, and obtain surface features of an object by 3D modeling, so as to generate the trajectory of the robot arm according to the surface features of the object. The offline programming can verify and simulate the trajectory of the robot arm, to reduce unnecessary errors in the actual operation of the robot arm.

The offline programming and the online programming have advantages and disadvantages, for example, the offline programming is suitable for programming the high-precision trajectory of the robot arm, to make the trajectory of the robot arm follow a straight line or track a specific motion pattern; in this case, the offline programming can provide performance better than the online programming using the teaching device to manually program the trajectory of the robotic arm. Relatively speaking, it is better to use the online programming when the uniqueness and flexibility of the motion of the robot arm must be considered first.

In general, most of the robotic arms in industrial production are used for works having repetitive processes, such as assembly, machining, welding, cutting, polishing, etc. For special process such as polishing, the offline programming can provide high-precision trajectories, but the high-precision trajectories for the object with high surface complexity often cause unexpected processing problems in the actual production process, such as failure of production with high-precision trajectory, or damage to objects caused by high-precision trajectory. On the other hand, the online programming can provide direct interaction and observe the state of the robot arm while the robot arm touches the object, so that the operational error of the robot arm can be effectively reduced. However, using the teaching device to manually remote control the robotic arm takes too much time to establish the trajectory of the robot arm.

Therefore, it is necessary to develop an improved technical solution to solve the conventional technology problem that the offline programming of robot arm trajectory may cause unexpected processing troubles in actual production and the online programming consumes too much time to establish the trajectory of the robot arm.

### SUMMARY

An objective of the present invention is to provide an offline-to-online programming teaching system for robot arm trajectory and a method thereof, to solve the conventional technology problem that the offline programming of robot arm trajectory may cause unexpected processing troubles in actual production and the online programming consumes too much time to establish trajectory of the robot arm.

In order to achieve the objective, the present invention provides an offline-to-online programming teaching system for robot arm trajectory of the present invention, and the offline-to-online programming teaching system includes a haptic device, a series robot arm and a trajectory conversion and control device. The trajectory conversion and control device includes an offline trajectory programming module, a simulation module, an offline trajectory conversion module, and an online control module.

The haptic device is configured to transmit a position command and a direction command, receive a guidance force information, and adjust the position command based on the guidance force information.

The series robot arm includes a moment/torque sensor and a polishing device disposed thereon, wherein an end position and an end direction of the series robot arm is controlled based on the received position command and direction command, controlled end position and controlled end direction of the series robot arm is transmitted.

The trajectory conversion and control device is interconnected to the haptic device and the series robot arm, and configured to receive the position command and the direction command from the haptic device, transmit the position command and the direction command to the series robot arm, receive the controlled end position and the controlled end direction of the series robot arm from the series robot arm, and transmit the guidance force information to the haptic device.

The offline trajectory programming module is configured to establish a computer-aided design model of the series robot arm and a computer-aided design model of a to-be-polished object, and establish an offline polishing reference trajectory based on the computer-aided design model of the series robot arm and the computer-aided design model of the to-be-polished object. The simulation module is configured to control the series robot arm to perform a polishing operation simulation for the to-be-polished object based on the offline polishing reference trajectory. When the simulation module controls the series robot arm to perform the polishing operation simulation for the to-be-polished object based on the offline polishing reference trajectory, the offline trajectory conversion module converts data flow of the simulation module into a polishing reference trajectory. The online control module is configured to calculate a deviation between the end position of the series robot arm and the polishing reference trajectory, generate the guidance force information, and transmit the guidance force information to the haptic device.

In order to achieve the objective, the present invention provides an offline-to-online programming teaching method for robot arm trajectory, and the offline-to-online programming teaching method includes steps of: establishing a computer-aided design model of a series robot arm and a computer-aided design model of a to-be-polished object, by a trajectory conversion and control device, wherein the series robot arm comprises a moment/torque sensor and a polishing device disposed thereon; establishing an offline polishing reference trajectory based in the computer-aided design model of the series robot arm and the computer-aided design model of the to-be-polished object, by the trajectory conversion and control device; controlling the series robot arm to perform a polishing operation simulation for the to-be-polished object based on the offline polishing reference trajectory, by the trajectory conversion and control device; when the trajectory conversion and control device controls the series robot arm to perform the polishing operation simulation for the to-be-polished object based on the offline polishing reference trajectory, converting data flow of the polishing operation simulation into a polishing reference trajectory, by the trajectory conversion and control device; transmitting a position command and a direction command, by the haptic device; interconnecting the trajectory conversion and control device to the haptic device and the series robot arm; receiving the position command and the direction command from the haptic device, by the trajectory conversion and control device; transmitting the position command and the direction command to the series robot arm, by the trajectory conversion and control device; controlling an end position and an end direction of the series robot arm based on the position command and the direction command, by the series robot arm; transmitting the controlled end position and the controlled end direction of the series robot arm to the trajectory conversion and control device, by the series robot arm; calculating a deviation between the end position of the series robot arm and the polishing reference trajectory to generate a guidance force information, by the trajectory conversion and control device; transmitting the guidance force information to the haptic device; adjusting the position command based on the guidance force information, by the haptic device.

According to the above-mentioned system and method of the present invention, the difference between the present invention and the conventional technology is that the trajectory conversion and control device establishes the offline polishing reference trajectory and performs the polishing operation simulation using the offline polishing reference trajectory. The trajectory conversion and control device converts the data flow of the simulation into the polishing reference trajectory. The trajectory conversion and control device calculates the deviation between the end position of the series robot arm and the polishing reference trajectory to generate the guidance force information. The haptic device adjusts the position command based on the guidance force information.

According to above-mentioned content, the present invention can achieve the technical effect of integrating offline-to-online programming to provide robot arm trajectory teaching.

### BRIEF DESCRIPTION OF THE DRAWINGS

The structure, operating principle and effects of the present invention will be described in detail by way of various embodiments which are illustrated in the accompanying drawings.

FIG. 1 is a block diagram of an offline-to-online programming teaching system for robot arm trajectory, according to the present invention.

FIG. 2 is a schematic view of an architecture of an offline-to-online programming teaching system for robot arm trajectory, according to the present invention.

FIG. 3 is a block diagram showing an operation of generating a guidance force information in an offline-to-online programming teaching system for robot arm trajectory, according to the present invention.

FIGS. 4A and 4B are schematic views showing an operation range used in an offline-to-online programming teaching system for robot arm trajectory, according to the present invention.

FIGS. 5A and 5B are flowcharts of an offline-to-online programming teaching method for robot arm trajectory, according to the present invention.

### DETAILED DESCRIPTION

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include”, and variations such as “comprises”, “comprising”, “includes”, or “including”, will be acknowledged to imply the inclusion of stated elements but not the exclusion of any other elements.

The implementation of the present invention will be illustrated in detail in the following paragraphs with reference to the accompanying drawings and embodiments, to clearly describe the implementation process that the technical solution of the present invention solves the technical problem to achieve technical effect.

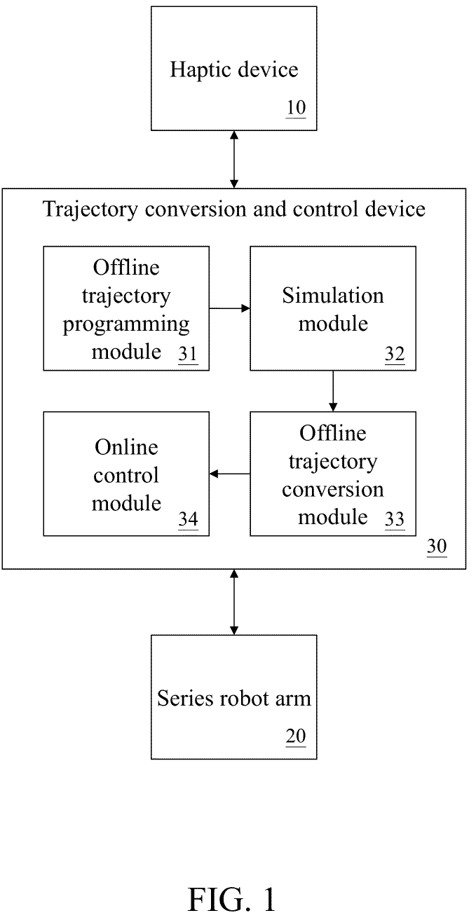

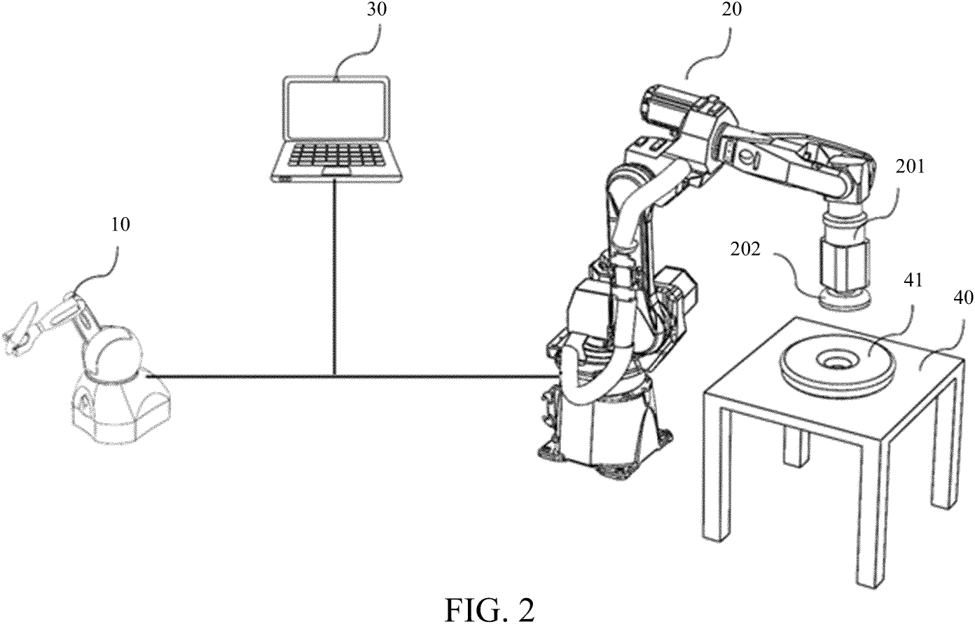

The offline-to-online programming teaching system of the present invention will be described in the following paragraphs. Please refer to FIGS. 1 and 2. FIG. 1 is a block diagram of an offline-to-online programming teaching system for robot arm trajectory, according to the present invention, and FIG. 2 is a schematic view showing an architecture of the offline-to-online programming teaching system for robot arm trajectory, according to the present invention.

The offline-to-online programming teaching system of the present invention includes a haptic device 10, a series robot arm 20, and a trajectory conversion and control device 30. The trajectory conversion and control device 30 includes an offline trajectory programming module 31, a simulation module 32, an offline trajectory conversion module 33, and an online control module 34.

The to-be-polished object 41 is fastened on the polishing platform 40, so that the to-be-polished object 41 is prevented from being moved by an external force when the series robot arm 20 performs a polishing operation on the to-be-polished object 41; furthermore, the fastening the to-be-polished object 41 on the polishing platform 40 can also locate the computer-aided design model of the to-be-polished object 41 established by the offline trajectory programming module 31 of the trajectory conversion and control device 30 at a practical position.

The series robot arm 20 includes a moment/torque sensor 201 and a polishing device 202 disposed thereon, the polishing device 202 is configured to perform the polishing operation on the to-be-polished object 41 through the series robot arm 20, and the moment/torque sensor 201 is configured to sense a haptic force of the polishing device 202 applied on the to-be-polished object 41 during the polishing operation.

The offline trajectory programming module 31 of the trajectory conversion and control device 30 establishes the computer-aided design model of the series robot arm 20, the offline trajectory programming module 31 of the trajectory conversion and control device 30 can establish an offline polishing reference trajectory based on the computer-aided design model of the series robot arm 20 and the computer-aided design model of the to-be-polished object 41.

After the offline trajectory programming module 31 of the trajectory conversion and control device 30 establishes the offline polishing reference trajectory, the simulation module 32 of the trajectory conversion and control device 30 performs a polishing operation simulation for the to-be-polished object 41 based on the computer-aided design model of the series robot arm 20, and the computer-aided design model of the to-be-polished object 41, and the offline polishing reference trajectory.

When the simulation module 32 of the trajectory conversion and control device 30 performs the polishing operation simulation for the to-be-polished object 41, the offline trajectory conversion module 33 of the trajectory conversion and control device 30 converts data flow of the polishing operation simulation of the simulation module 32 of the trajectory conversion and control device 30 into the polishing reference trajectory; that is, the offline trajectory conversion module 33 of the trajectory conversion and control device 30 periodically obtain an end position and an end direction of the series robot arm 20 from the data flow of the simulation module 32 of the trajectory conversion and control device 30, to generate the polishing reference trajectory based on the obtained end positions and end directions of the series robot arm 20 in sequential order.

The haptic device 10 can be interconnected to the series robot arm 20 and the trajectory conversion and control device 30 through a wired transmission manner or a wireless transmission manner. In an embodiment, the wired transmission manner can be, for example, power line network or optical network; the above-mentioned wireless transmission manner can be, for example, Wi-Fi or mobile communication network (such as 3G, 4G 5G); however, these examples are merely for exemplary illustration, the application field of the present invention is not limited to these examples.

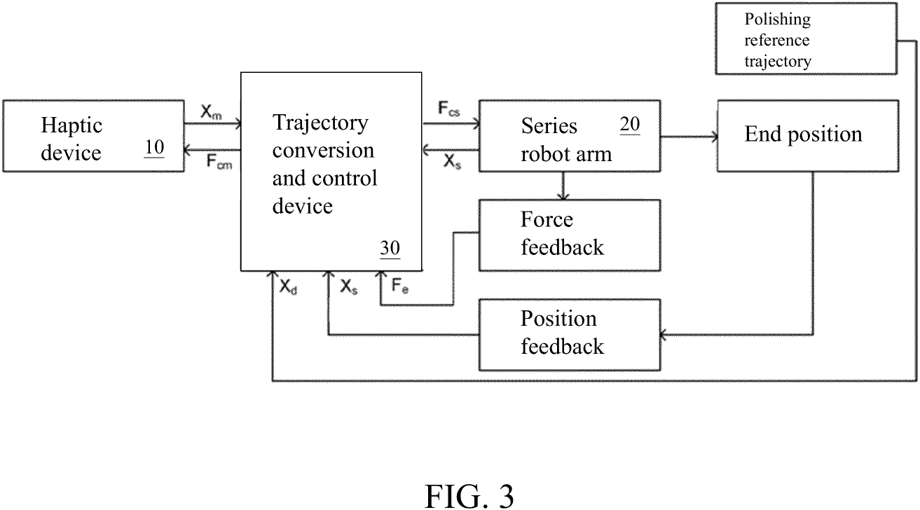

Please refer to FIG. 3, which is a block diagram showing an operation of generating a guidance force information in an offline-to-online programming teaching system for robot arm trajectory, according to the present invention.

The haptic device 10 is configured to provide a user to remotely control the series robot arm 20, the user can operate the haptic device 10 to transmit a position command and a direction command, the trajectory conversion and control device 30 receives the position command and the direction command from the haptic device 10, the position command and the direction command are used to control the end position and the end direction of an end of the series robot arm 20, and the end position and the end direction of the end of the series robot arm 20 are the position and the direction of the polishing device 202.

The trajectory conversion and control device 30 transmits the position command and the direction command to the series robot arm 20, so that the series robot arm 20 is able to control the end position and the end direction thereof based on the received position command and direction command, and the series robot arm 20 then sends the controlled end position and the end direction of the series robot arm 20 back to the trajectory conversion and control device 30.

The online control module 34 of the trajectory conversion and control device 30 calculates a deviation between the end position of the series robot arm 20 and the polishing reference trajectory to generate a guidance force information. When the trajectory conversion and control device 30 generates the guidance force information, the trajectory conversion and control device 30 transmits the guidance force information to the haptic device 10.

It should be noted that the deviation between the end position of the series robot arm 20 and the polishing reference trajectory is proportional to the guidance force information; that is, when the deviation between the end position of the series robot arm 20 and the polishing reference trajectory become greater, the guidance force information calculated by the trajectory conversion and control device 30 indicates a greater value; in contrast, when the deviation between the end position of the series robot arm 20 and the polishing reference trajectory become smaller, the guidance force information calculated by the trajectory conversion and control device 30 indicates a smaller value.

When receiving the guidance force information from the trajectory conversion and control device 30, the haptic device 10 enables the user to feel the guidance force information from the haptic device 10, so that the user can operate the haptic device 10 to control the end position of the series robot arm 20 again to operate the haptic device 10 to adjust the position command based on a size of the guidance force information; that is, the user is able to feel the guidance force information to operate the haptic device 10 for adjustment.

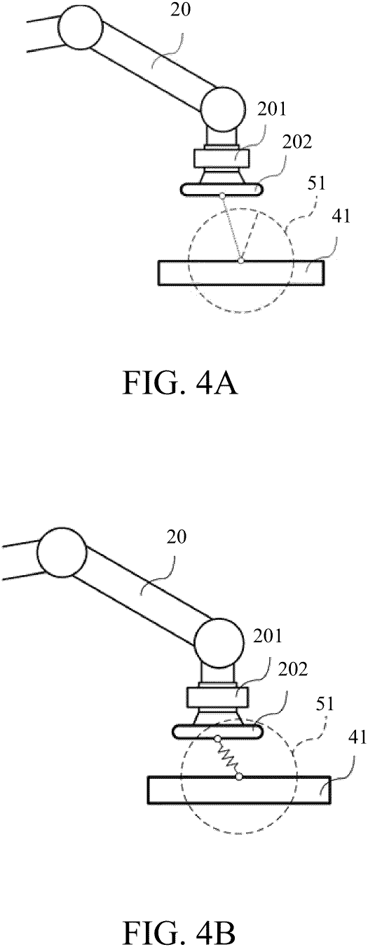

Please refer to FIG. 4A, which is a schematic view of an operation range used in an offline-to-online programming teaching system for robot arm trajectory, according to the present invention.

In order to provide the user to smoothly operate the haptic device 10, an operation range 51 can be set for the to-be-polished object 41. When the position (that is, the end position) of the polishing device 202 of the series robot arm 20 is inside the operation range 51, the trajectory conversion and control device 30 transmits the guidance force information to the haptic device 10, as shown in FIG. 4A, the position of the polishing device 202 of the series robot arm 20 is outside the operation range 51 set for the to-be-polished object 41, so the trajectory conversion and control device 30 stops transmitting the guidance force information to the haptic device 10, in this case, the user can freely operate the haptic device 10 to control the series robot arm 20.

Please refer to FIG. 4B, which is a schematic view of the operation range in an offline-to-online programming teaching system for robot arm trajectory, according to the present invention.

As shown in FIG. 4B, when the position of the polishing device 202 of the series robot arm 20 is inside the operation range 51 set for the to-be-polished object 41, the trajectory conversion and control device 30 transmits the guidance force information to the haptic device 10, the user can feel the guidance force information through the haptic device 10, so as to operate the haptic device 10 to control the end position of the series robot arm 20 again according to a size of the guidance force information.

In an embodiment, the series robot arm 20 has six degrees of freedom (DOF), the moment/torque sensor 201 of the series robot arm 20 senses a haptic force generated when the polishing device 202 touches the to-be-polished object 41, the series robot arm 20 transmits the haptic force to the trajectory conversion and control device 30.

The trajectory conversion and control device 30 receives the haptic force from the series robot arm 20, the trajectory conversion and control device 30 transmits the haptic force to the haptic device 10, so that the user can feel the haptic force through the haptic device 10; when the haptic force is greater than 0, it indicates that the polishing device of the series robot arm 20 has touched the to-be-polished object, the trajectory conversion and control device 30 transmits an adjustment parameter to the series robot arm 20, the series robot arm 20 further controls the motion thereof based on the adjustment parameter; the adjustment parameter can be used to adjust operational ratio of the series robot arm 20, to control the haptic force not to exceed the preset value, so as to prevent the user from damaging the surface of the to-be-polished object 41 because of incorrect operating the haptic device 10 or subject to uncontrolled external force during the polishing operation for the to-be-polished object 41. The preset value represents maximum contact force when the polishing device 202 touches the to-be-polished object 41. It is adjusted in accordance with the characteristics of the to-be-polished object 41.

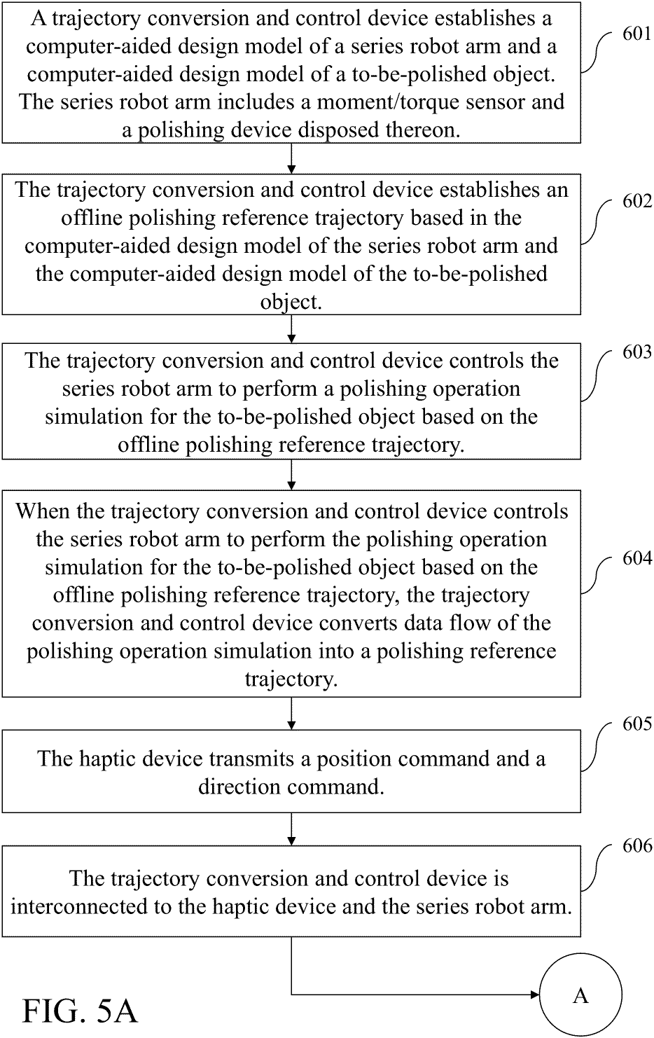

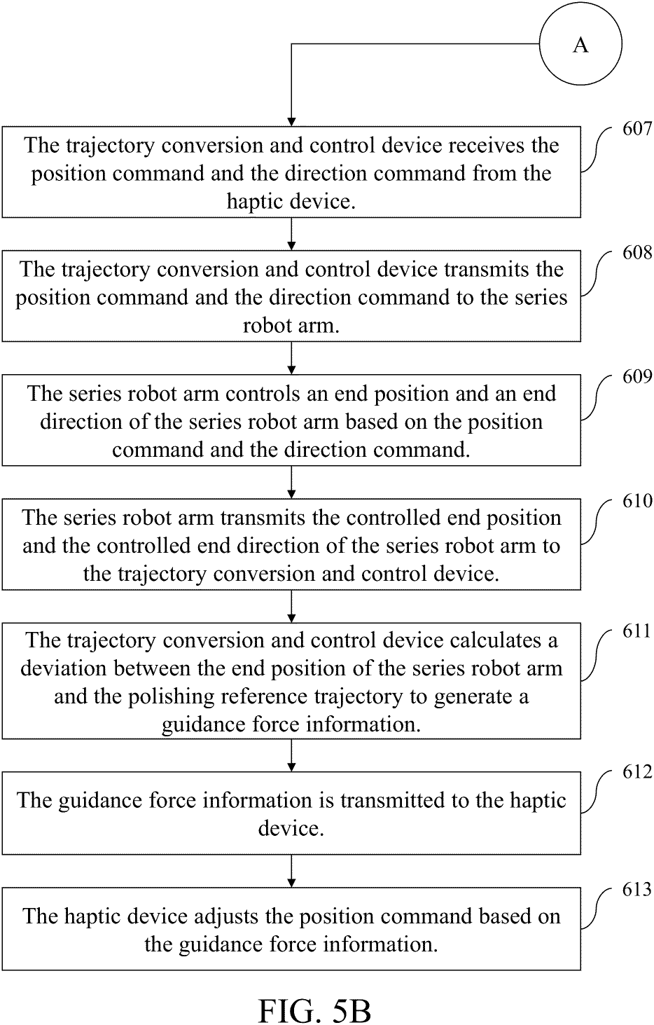

The operations of the system and method of an embodiment of the present invention will be described in the following paragraphs. Please refer to FIGS. 5A and 5B, which are flowcharts of an offline-to-online programming teaching method for robot arm trajectory, according to the present invention.

As shown in FIGS. 5A and 5B, the offline-to-online programming teaching method of the present invention includes the following steps.

In a step 601, a trajectory conversion and control device establishes a computer-aided design model of a series robot arm and a computer-aided design model of a to-be-polished object. The series robot arm includes a moment/torque sensor and a polishing device disposed thereon. In a step 602, the trajectory conversion and control device establishes an offline polishing reference trajectory based in the computer-aided design model of the series robot arm and the computer-aided design model of the to-be-polished object. In a step 603, the trajectory conversion and control device controls the series robot arm to perform a polishing operation simulation for the to-be-polished object based on the offline polishing reference trajectory. In a step 604, when the trajectory conversion and control device controls the series robot arm to perform the polishing operation simulation for the to-be-polished object based on the offline polishing reference trajectory, the trajectory conversion and control device converts data flow of the polishing operation simulation into a polishing reference trajectory. In a step 605, the haptic device transmits a position command and a direction command. In a step 606, the trajectory conversion and control device is interconnected to the haptic device and the series robot arm. In a step 607, the trajectory conversion and control device receives the position command and the direction command from the haptic device. In a step 608, the trajectory conversion and control device transmits the position command and the direction command to the series robot arm. In a step 609, the series robot arm controls an end position and an end direction of the series robot arm based on the position command and the direction command. In a step 610, the series robot arm transmits the controlled end position and the controlled end direction of the series robot arm to the trajectory conversion and control device. In a step 611, the trajectory conversion and control device calculates a deviation between the end position of the series robot arm and the polishing reference trajectory to generate a guidance force information. In a step 612, the guidance force information is transmitted to the haptic device. In a step 613, the haptic device adjusts the position command based on the guidance force information.

Therefore, the difference between the present invention and the conventional technology is that the trajectory conversion and control device establishes the offline polishing reference trajectory and performs the polishing operation simulation using the offline polishing reference trajectory. The trajectory conversion and control device converts the data flow of the simulation into the polishing reference trajectory. The trajectory conversion and control device calculates the deviation between the end position of the series robot arm and the polishing reference trajectory to generate the guidance force information. The haptic device adjusts the position command based on the guidance force information.

Therefore, the technical solution of the present invention is able to solve the problem that the offline programming for the robot arm trajectory may cause unexpected processing troubles in actual production and the online programming consumes too much time to establish the robot arm trajectory, so as to achieve the technical effect of integrating offline-to-online programming to provide robot arm trajectory teaching.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. An offline-to-online programming teaching system for robot arm trajectory, comprising:
a haptic device configured to transmit a position command and a direction command, receive a guidance force information, and adjust the position command based on the guidance force information;
a series robot arm comprising a moment/torque sensor and a polishing device disposed thereon, wherein an end position and an end direction of the series robot arm is controlled based on the received position command and direction command, controlled end position and controlled end direction of the series robot arm is transmitted;
a trajectory conversion and control device interconnected to the haptic device and the series robot arm, and configured to receive the position command and the direction command from the haptic device, transmit the position command and the direction command to the series robot arm, receive the controlled end position and the controlled end direction of the series robot arm from the series robot arm, and transmit the guidance force information to the haptic device, wherein the trajectory conversion and control device comprises:
an offline trajectory programming module configured to establish a computer-aided design model of the series robot arm and a computer-aided design model of a to-be-polished object, and establish an offline polishing reference trajectory based on the computer-aided design model of the series robot arm and the computer-aided design model of the to-be-polished object;
a simulation module configured to control the series robot arm to perform a polishing operation simulation for the to-be-polished object based on the offline polishing reference trajectory;
an offline trajectory conversion module, wherein when the simulation module controls the series robot arm to perform the polishing operation simulation for the to-be-polished object based on the offline polishing reference trajectory, the offline trajectory conversion module converts data flow of the simulation module into a polishing reference trajectory; and
an online control module configured to calculate a deviation between the end position of the series robot arm and the polishing reference trajectory, generate the guidance force information, and transmit the guidance force information to the haptic device.

2. The offline-to-online programming teaching system for robot arm trajectory according to claim 1, wherein the offline trajectory conversion module periodically obtains the end position of the series robot arm from the data flow of the simulation module, and generates the polishing reference trajectory based on the end positions of the series robot arms in sequential order, so as to convert the data flow of the simulation module into the polishing reference trajectory.

3. The offline-to-online programming teaching system for robot arm trajectory according to claim 1, wherein the deviation between the end position of the series robot arm and the polishing reference trajectory is proportional to the guidance force information.

4. The offline-to-online programming teaching system for robot arm trajectory according to claim 1, wherein the trajectory conversion and control device is set with an operation range for the to-be-polished object, and when the deviation between the end position of the series robot arm and the polishing reference trajectory is greater than the operation range, the trajectory conversion and control device stops transmitting the guidance force information to the haptic device.

5. The offline-to-online programming teaching system for robot arm trajectory according to claim 1, wherein the moment/torque sensor senses a haptic force of the polishing device performing a polishing operation on the to-be-polished object, the trajectory conversion and control device receives the haptic force from the series robot arm, the trajectory conversion and control device transmits the haptic force to the haptic device, wherein when the haptic force is greater than zero, the trajectory conversion and control device transmits an adjustment parameter to the series robot arm, the adjustment parameter is used to adjust an operational ratio of the series robot arm to prevent the haptic force from exceeding a preset value.

6. An offline-to-online programming teaching method for robot arm trajectory, comprising:
establishing a computer-aided design model of a series robot arm and a computer-aided design model of a to-be-polished object, by a trajectory conversion and control device, wherein the series robot arm comprises a moment/torque sensor and a polishing device disposed thereon;
establishing an offline polishing reference trajectory based in the computer-aided design model of the series robot arm and the computer-aided design model of the to-be-polished object, by the trajectory conversion and control device;
controlling the series robot arm to perform a polishing operation simulation for the to-be-polished object based on the offline polishing reference trajectory, by the trajectory conversion and control device;
when the trajectory conversion and control device controls the series robot arm to perform the polishing operation simulation for the to-be-polished object based on the offline polishing reference trajectory, converting data flow of the polishing operation simulation into a polishing reference trajectory, by the trajectory conversion and control device;
transmitting a position command and a direction command, by the haptic device;
interconnecting the trajectory conversion and control device to the haptic device and the series robot arm;
receiving the position command and the direction command from the haptic device, by the trajectory conversion and control device;
transmitting the position command and the direction command to the series robot arm, by the trajectory conversion and control device;
controlling an end position and an end direction of the series robot arm based on the position command and the direction command, by the series robot arm;
transmitting the controlled end position and the controlled end direction of the series robot arm to the trajectory conversion and control device, by the series robot arm;
calculating a deviation between the end position of the series robot arm and the polishing reference trajectory to generate a guidance force information, by the trajectory conversion and control device;
transmitting the guidance force information to the haptic device; and
adjusting the position command based on the guidance force information, by the haptic device.

7. The offline-to-online programming teaching method for robot arm trajectory according to claim 6, wherein the step of converting the data flow of the simulation module into the polishing reference trajectory by the offline trajectory conversion module, comprises:
the periodically obtaining the end position of the series robot arm from the data flow of the simulation module, and generating the polishing reference trajectory based on the end positions of the series robot arms in sequential order, by the offline trajectory conversion module.

8. The offline-to-online programming teaching method for robot arm trajectory according to claim 6, wherein the deviation between the end position of the series robot arm and the polishing reference trajectory is proportional to the guidance force information.

9. The offline-to-online programming teaching method for robot arm trajectory according to claim 6, further comprising:
setting an operation range for the to-be-polished object in the trajectory conversion and control device; and
when the deviation between the end position of the series robot arm and the polishing reference trajectory is greater than the operation ranges, stopping the trajectory conversion and control device from transmitting the guidance force information to the haptic device.

10. The offline-to-online programming teaching method for robot arm trajectory according to claim 6, further comprising:
sensing a haptic force of the polishing device performing a polishing operation on the to-be-polished object, by the moment/torque sensor;
receiving the haptic force from the series robot arm, by the trajectory conversion and control device;
transmitting the haptic force to the haptic device, by the trajectory conversion and control device;
when the haptic force is greater than zero, transmitting an adjustment parameter to the series robot arm, by the trajectory conversion and control device; and
adjusting an operational ratio of the series robot arm to prevent the haptic force from exceeding a preset value based on the adjustment parameter.
